(19) United States
(12) Patent Application Publication
(10) Pub. No.: US 2025/0004723 A1
(43) Pub. Date: Jan. 2, 2025

(54) RANDOM NUMBER GENERATION USING SPARSE NOISE SOURCE

(71) Applicant: Synopsys, Inc., Sunnyvale, CA (US)

(72) Inventor: Roel MAES, Eindhoven (NL)

(21) Appl. No.: 18/694,863

(22) PCT Filed: Sep. 7, 2022
(86) PCT No.: PCT/EP2022/074831

§ 371 Date: Mar. 22, 2024

(30) Foreign Application Priority Data
Sep. 23, 2021 (EP) 21198613.8

(51) Int. Cl. G06F 7/58; H04L 9/08

(52) U.S. Cl. CPC G06F 7/588; H04L 9/0869

(57) ABSTRACT

Some embodiments are directed to a random number generation device that obtains a noise source response sequence and concentrates entropy in the noise source response sequence by computing a matrix multiplication modulo a modulus between the matrix and a vector comprising the values in the noise source response sequence.

### TECHNICAL FIELD

The presently disclosed subject matter relates to a random number generation device, a random number generation method, a computer readable medium.

### BACKGROUND

Physically unclonable functions (PUFs) are used for a variety of applications. An important application is for the secure and repeated generation of a cryptographic key, e.g., as an alternative to storing a cryptographic key in a secure memory. Although PUFs are by nature noisy, repeated read-outs of the same PUF will be the same to such an extent that the same cryptographic key can be repeatedly generated from the different PUF responses. Typically, this will involve so-called helper data, which steers the key reconstruction towards the same key each time, or substantially each time, the PUF is read out again, e.g., powered-up again. This application relies on the fact that a sufficiently large part of the PUF output is consistent, e.g., will be substantially the same on subsequent readings with high probability. Another application is device identification or anti-counterfeiting, in which a device is identified from its PUF output. Another application is the creation of cryptographic keys.

An SRAM PUF can be created from a conventional SRAM memory, by reading out its power-up values. This leverages the fact that the power-up values of an array of SRAM memory are unique as seen over different devices, yet highly repeatable for the same SRAM memory. Only a small proportion of the SRAM cells produces randomly varying values every time its power-up values are being measured.

As some parts of a PUF are noisy, another application of a PUF is the generation of random numbers. A known use of a PUF for random number generation is described in the paper “Efficient Implementation of True Random Number Generator based on SRAM PUFs”, by Vincent van der Leest, et al., and included herein by reference. There are many other applicable type of PUFs, e.g., Butterfly PUFs and so on.

For example, in the known use of a PUF for random number generation, cited above, a cryptographic hash function, SHA-256, is applied to a string of 1600 bits of SRAM power-up values, thus obtaining an output string of length 256 bits. The output string is used as a random seed for a deterministic random bit generator (DRBGs) which converts the seed into a stream of random bits.

Generation of random numbers is an important application. Many cryptographic protocols rely on random numbers to provide their security. For example, random numbers may be used in encryption, e.g., to select a cryptographic key, select a random initialization vector for chaining modes of block ciphers, randomize a message, etc. Random numbers may be needed in asymmetric algorithms as well, e.g., in the ECDSA signature algorithm or in padding functions, e.g., RSA-OAEP, and so on. Without having a reliable source of random numbers, many cryptographic protocols and algorithms could be compromised, or may have reduced security. At the same time, cryptography is increasingly used on devices which do not have a reliable entropy source for high quality random number generation. For example, with the uptake of such projects as the internet of things, or increased application of small-form factor sensor devices, smart-cards, mobile devices and so on, there is an increased reliance on cryptography for security, and thus on random numbers.

The generation of random numbers, collection of entropy and the like thus needs to be of high quality.

### SUMMARY

A problem with the known application of PUFs for random number generation is that the quality of the random number generation cannot easily be monitored. Although, in case of an SRAM PUF a small percentage of the bit cells shows noisy power-up behavior and thus contributes noise entropy, the locations of the noisy, entropy-carrying cells are randomly distributed over the entire cell array, and are a-priori unknown. For the purpose of this document, generation of random numbers, random values, or random bits all boil down to the same thing, and these terms will be used interchangeably.

The inventor found that the power-up values in an SRAM PUF show what is known as sparse noise. Sparse noise is also known as salt-and-pepper noise, impulse noise, or spike noise; Noisy bits occurring infrequently and in unpredictable locations. While most PUF response bits are the same after repeated power-ups of the same PUF, some show different values. In the technical field of image processing, for example, sparse noise is a nuisance, and algorithms are known to remove such sparse noise. See, e.g., the papers “Image Noise Reduction and Filtering Techniques”, by Abdalla Mohamed Hambal, et al., and “A Fast Iterative Method for Removing Impulsive Noise from Sparse Signals”, by Sahar Sadrizadeh, et al. However, whereas in the field of image processing it is a goal to remove the sparse noise from an image, when using a PUF for random number generation, one aims to collect the entropy from the PUF as a sparse noise source.

As pointed out above, the known random number generator based on SRAM PUFs uses a cryptographic hash function such as SHA-256 to compress a larger amount of PUF response bits, e.g., 1600 bits or so, or more, to a smaller output string, in this case, of 256 bit. Implicitly, it is assumed that whatever entropy is available in the PUF output will be garnered in the output string. If one assumes the entropy in the PUF response was high enough, then the entropy in the concentrated string would also be high enough. When enough bits are used on the input side, the concentrated sequence will probably have sufficient entropy for most applications. One could, e.g., characterize and model the noise source, which in turn may be used to estimate the entropy in the concentrated output, and the likelihood that the amount of entropy will be sufficiently high or not.

For some applications, this will not be enough though. Although a cryptographic hash function will likely perform this function of entropy concentration, it has an important downside. Applying statistical tests to the concentrated output becomes meaningless. A cryptographic hash function is designed for its output to resemble a random bit string as much as possible. Applying such a hash function to any input string, whether with high entropy or with low entropy, its output will look fully random. This means that statistical tests cannot meaningfully be applied to the output string. Even a high-powered off-line test, with access to multiple measurements, would not be sufficient, as any minor change in the input would cause a completely different concentrated sequence. In fact, a hypothetical test which would be able to do this would in fact constitute an attack on the cryptographic hash function, which is widely considered to be infeasible for modern hash functions.

Entropy estimates performed on one such sequence that was concentrated with a hash function would be very high, even if this were unjustified. On the other hand, applying statistical test to the input will be hard-pressed to estimate the input entropy, as the entropy is sparse. Known standards on randomness generation, e.g., the NIST standard, deal poorly with this sparse entropy, resulting in significant under-estimations of the real entropy, or even an outright disqualification of the entropy source. In many applications such standardized entropy tests are mandatory, further exacerbating the problem.

In an embodiment, a new concentration function is proposed that can be used to obtain high-entropy noise data from a sparse noise source, that is, a source whose noise entropy is contained in a limited number of a-priori unknown bit locations. Such a source typically comprises a large number of bits, e.g., the majority, with low or zero entropy. Such a sparse noise behavior is seen in PUFs, e.g., at the startup values of SRAM PUFs, and other PUFs like Butterfly PUFs. However, the concentration function does not obscure statistical relations between input bits, so that statistical analysis of the output string remains meaningful. Using a hash function to concentrate entropy would obfuscate the statistical properties of the physical behavior that the noise source relies on as the origin of the noise entropy. For example, in a sparse noise source, 90% or more of the values in the output sequence may have an entropy of 0.1 bit or less. The entropy considered here, is the entropy when comparing multiple measurements of the same noise source, e.g., after a power-cycle or other re-excitation of the PUF circuitry. This entropy should not be confused with the differences that exist when two different noise sources are read out, say reading out the PUFs of two different devices; the latter differences are typically much larger.

A random number generation device may comprise a sparse noise interface configured to obtain a noise source response sequence of values from a sparse noise source, the sequence comprising both noisy values and non-noisy values.

Sparse noise sources are advantageous because they can be used both for reconstructable cryptographic keys, device identification, and the like, due to a high number of stable cells, but at the same time, they can also be used as a source of randomness, due to the occurrence of unstable cells. In an embodiment, a first part of a PUF output is used for random number generation, and a second part for key generation or device identification. In an embodiment, the first and second part do not overlap. In an embodiment, the first and second part fully or partially overlap.

The values produced by the noise source are typically bits, but this is not necessary. For example, a PUF such as a coating PUF or a delay PUF may produce floating point values, which in turn may be mapped to more than 2 discrete values.

The random number generation device may comprise a matrix storage configured to store a matrix arranged for entropy concentration, the matrix having a different number of columns than rows. The matrix may be the same matrix used on multiple devices, or the matrix may be specific to a device. The matrix is not necessarily secret, though in an embodiment, the matrix can be kept secret, e.g., by storing it in encrypted form, or in a secure memory, to make reverse engineering difficult.

The random number generation device may be configured to concentrate entropy in the noise source response sequence by computing a matrix multiplication modulo a modulus between the matrix and a vector comprising the values in the noise source response sequence. In this way a concentrated sequence of random values is obtained, the concentrated sequence comprising fewer values than the sequence of noise source response values. Note that a matrix multiplication can be implemented in a number of ways.

One or more pre-processing operations may be applied to the noise source response sequence, e.g., to the source bits. Corresponding pre-processing operations may or may not be applied to the matrix. For example, some bits of the source may be omitted before starting the matrix operation. Rows and/or columns that correspond to an omitted input bit may be omitted also (depending on whether column or row vectors are used). For example, bits that are known to have low entropy on a particular device, may be omitted from entropy concentration. Especially, if many bits can be excluded in this manner the concentration operation can be sped up. For example, on a PUF type where low-entropy bits tend to cluster, it may be advantageous to apply a permutation to the input bits before applying the matrix concentration. The permutation may be random or pseudorandom, while the matrix operation may be fixed, e.g., correspond to a particular error correcting code. For example, the permutation may be selected randomly for each device while the matrix operation may be fixed. Various ways exist to encode a permutation, e.g., the permutation may be stored in Lehmer code.

The sparse noise source may comprise multiple sparse noise source elements, each configured to produce one value of the noise source response sequence. The noise source response sequence may be obtained from the sparse noise source by collecting the multiple values of the multiple sparse noise source elements. The elements may be memory elements, e.g., SRAM memory elements, but this is not necessary. For example, the noise source elements, or cells, may be flip-flops, bus keepers or the like. For example, the noise source elements, or cells, may be FPGA structures implementing or simulating these elements, e.g., SRAM memory cells. A particular good example of an FPGA implemented noise cells are Butterfly PUF elements. The butterfly PUF is for example described in the paper “The butterfly PUF protecting IP on every FPGA” by Sandeep S. Kumar; Jorge Guajardo; Roel Maes; Geert-Jan Schrijen; Pim Tuyls; or in the paper “The Butterfly PUF: Protecting IP on every FPGA” by S. S. Kumar, J. Guajardo, R. Maes, G. J. Schrijen, and P. Tuyls.

Typically, one relies on the natural randomness introduced during normal manufacturing process. For some noise source types, especially, memory based, a power-cycle, is needed to refresh the randomness.

The matrix may be updated at some point, e.g., to improve entropy concentration. For example, this can be done in the form of a software update, or a reconfiguration of the device. The updated matrix may take better account of the number and location of unstable cells.

Many choices for the matrix are possible, but a particularly advantageous choice is the parity check matrix of a linear error correcting code. Note that, the parity check matrix of one linear error correcting code is the same as the generator matrix of another error correcting code, namely the dual error correcting code. Among parity check matrices, an especially good choice are the parity check matrices of Reed-Muller codes. The matrix typically comprises integer values, e.g., non-negative values.

The random number generation device is an electronic device, in particular a mobile electronic device, mobile phone, set-top box, smart-card, microcontroller, electronic control unit, Microprocessor, computer, FPGA, CPU, DPU, server, or the like.

A further aspect is a method of random number generation. The method of random number generation described herein may be applied in a wide range of practical applications. Such practical applications include: cryptography, testable random number generation, simulation, etc. An embodiment of the method may be implemented on a computer as a computer implemented method, or in dedicated hardware, or in a combination of both. Executable code for an embodiment of the method may be stored on a computer program product. Examples of computer program products include memory devices, optical storage devices, integrated circuits, servers, online software, etc. Preferably, the computer program product comprises non-transitory program code stored on a computer readable medium for performing an embodiment of the method when said program product is executed on a computer.

In an embodiment, the computer program comprises computer program code adapted to perform all or part of the steps of an embodiment of the method when the computer program is run on a computer. Preferably, the computer program is embodied on a computer readable medium.

Another aspect of the presently disclosed subject matter is a method of making the computer program available for downloading.

### BRIEF DESCRIPTION OF DRAWINGS

Further details, aspects, and embodiments will be described, by way of example only, with reference to the drawings. Elements in the figures are illustrated for simplicity and clarity and have not necessarily been drawn to scale. In the figures, elements which correspond to elements already described may have the same reference numerals. In the drawings,

FIG. 1a schematically shows an example of an embodiment of a random number generation device,

FIG. 1b schematically shows an example of an embodiment of a random number generation device,

FIG. 1c schematically shows an example of an embodiment of a random number generation device,

FIG. 1d schematically shows an example of an embodiment of a random number generation device,

FIG. 2a schematically shows an example of an embodiment of a random number generation device,

FIG. 2b schematically illustrates an example of an embodiment of multiple sparse noise source elements,

FIG. 2c schematically illustrates an example of an embodiment of response sequence of values,

FIG. 2d shows a typical shape of the one-probability distribution density for an SRAM cell,

FIG. 3a schematically illustrates an example of an embodiment of response sequence of values,

FIG. 3b schematically illustrates an example of an embodiment of concentrated sequence of values,

FIG. 4a schematically shows an example of an embodiment of a matrix generation system,

FIG. 4b schematically shows an example of an embodiment of a matrix generation system,

FIG. 5 schematically shows an example of an embodiment of a random number generation method,

FIG. 6a schematically shows a computer readable medium having a writable part comprising a computer program according to an embodiment,

FIG. 6b schematically shows a representation of a processor system according to an embodiment.

### REFERENCE SIGNS LIST

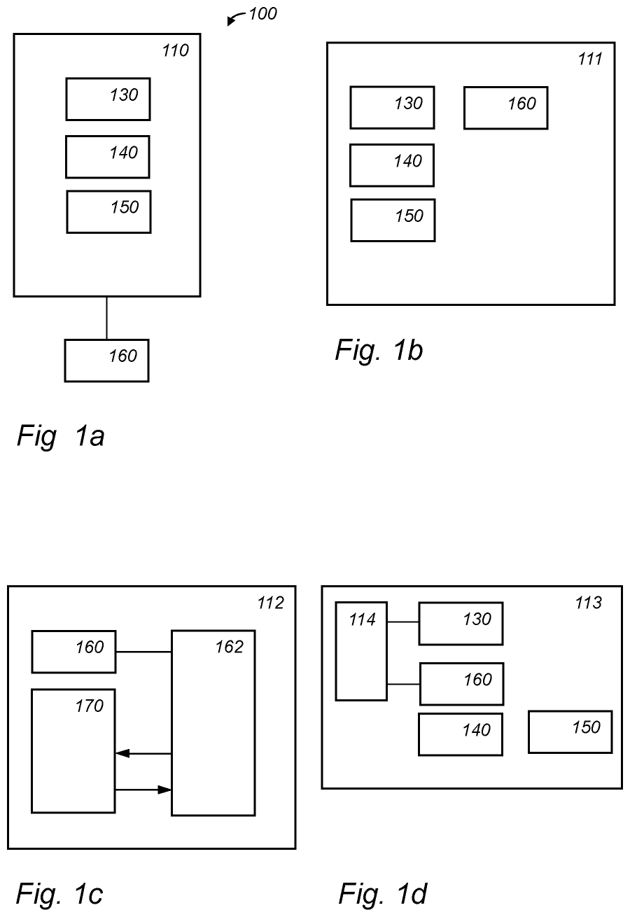

The following list of references and abbreviations corresponds to FIGS. 1a-4b, 6a-6b, and is provided for facilitating the interpretation of the drawings and shall not be construed as limiting the claims.
100 a random number generation system
110-114 a random number generation device
130 a processing system
140 a storage
150 a communication interface
160 a sparse noise source
162 entropy processing unit
170 a computation unit
200 a random number generation system
210 a matrix storage
260 a sparse noise source
261 multiple sparse noise source elements
262 multiple sparse noise source response values
265 a sparse noise interface
270 a noise source response sequence
272 a concentrated sequence
281 a first test unit
282 a second test unit
285 an application
290 an entropy concentration unit
300, 301 a configuration system
310 a random number generation device
320 a configuration device
360 a matrix generation unit
365 sparse noise interface
370 multiple noise source response sequences
371-373 a noise source response sequence
1000, 1001 a computer readable medium
1010 a writable part
1020 a computer program
1110 integrated circuit(s)
1120 a processing unit
1122 a memory
1124 a dedicated integrated circuit
1126 a communication element
1130 an interconnect
1140 a processor system

### DESCRIPTION OF EMBODIMENTS

While the presently disclosed subject matter is susceptible of embodiment in many different forms, there are shown in the drawings and will herein be described in detail one or more specific embodiments, with the understanding that the present disclosure is to be considered as exemplary of the principles of the presently disclosed subject matter and not intended to limit it to the specific embodiments shown and described.

In the following, for the sake of understanding, elements of embodiments are described in operation. However, it will be apparent that the respective elements are arranged to perform the functions being described as performed by them.

Further, the subject matter that is presently disclosed is not limited to the embodiments only, but also includes every other combination of features described herein or recited in mutually different dependent claims.

FIG. 1a schematically shows an example of an embodiment of a random number generation system 100. System 100 comprises a random number generation device 110 and a sparse noise source 160. For example, the random number generation device 110 may be configured to receive a response from the sparse noise source 160 and to concentrate the entropy contained in the noise source response.

Random number generation device 110 may comprise a processing system 130, a storage 140, and a communication interface 150. Storage 140 may comprise local storage, e.g., a local hard drive or electronic memory. Storage 140 may comprise non-local storage, e.g., cloud storage. In the latter case, storage 140 may comprise a storage interface to the non-local storage.

Random number generation device 110 may communicate internally, with other systems, external storage, input devices, output devices, and/or one or more sensors over a computer network. The computer network may be an internet, an intranet, a LAN, a WLAN, etc. The computer network may be the Internet. The system comprises a connection interface which is arranged to communicate within the system or outside of the system as needed. For example, the connection interface may comprise a connector, e.g., a wired connector, e.g., an Ethernet connector, an optical connector, etc., or a wireless connector, e.g., an antenna, e.g., a Wi-Fi, 4G or 5G antenna.

Communication inside random number generation system 100 may use a variety of methods; for example, internal communication, e.g., between different sub-systems may be over an internal bus or interface, e.g., APB bus.

The communication interface 150 may comprise a sparse noise interface configured to obtain a noise source response sequence of values from sparse noise source 160. The sparse noise interface may be digital. The sparse noise interface may be internal to device 110. The sparse noise source may in particular be a PUF, although this is not necessary.

In device 110 and/or system 100, the communication interface 150 may be used to send or receive digital data. For example, device 110 may be further configured to cryptographic tasks, e.g., encryption and/or decryption of data, signing and/or verification of data. Such encrypted data and/or signature may be sent and received by device 110 via interface 150. Such cryptographic tasks may use random numbers generated from the sparse noise source.

For example, the communication interface 150 may be configured to obtain a noise source response sequence of values from sparse noise source 160. For example, storage 140 may be configured to store a matrix arranged for entropy concentration. For example, the processor system 130 may be configured to concentrate entropy in the noise source response sequence by computing a matrix multiplication between the matrix and a vector comprising the values in the noise source response sequence, thus obtaining a concentrated sequence of random values.

The execution of system 100 may be implemented in processor system 130, e.g., one or more processor circuits, e.g., microprocessors, examples of which are shown herein. The processor system 130 may comprise one or more GPUs and/or CPUs. System 100 may comprise multiple processors, which may be distributed over different locations. For example, system 100 may use cloud computing. Processor system 130 may comprise one or more microprocessors, which may be in a single device, or in a distributed device; typically, system 100 is implemented in a single device though.

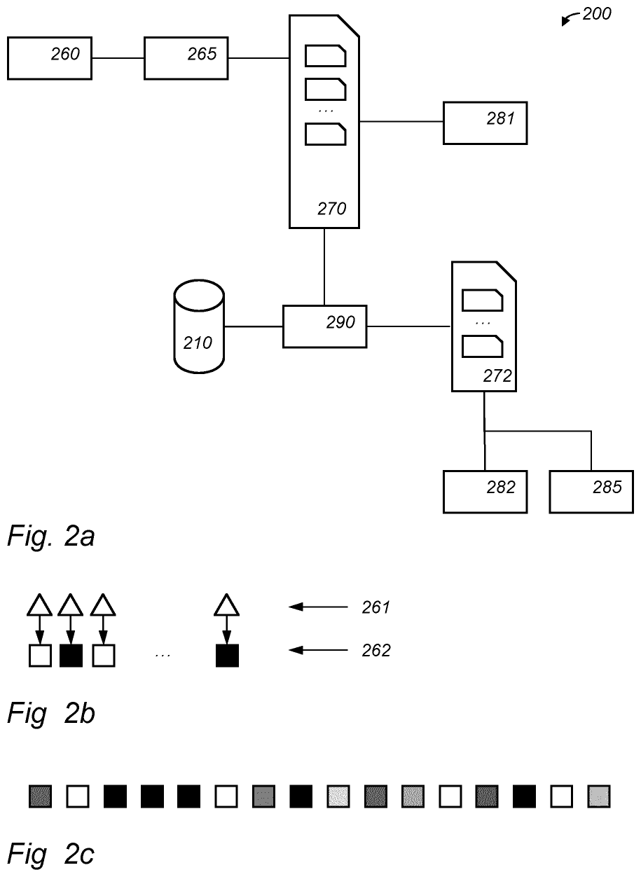

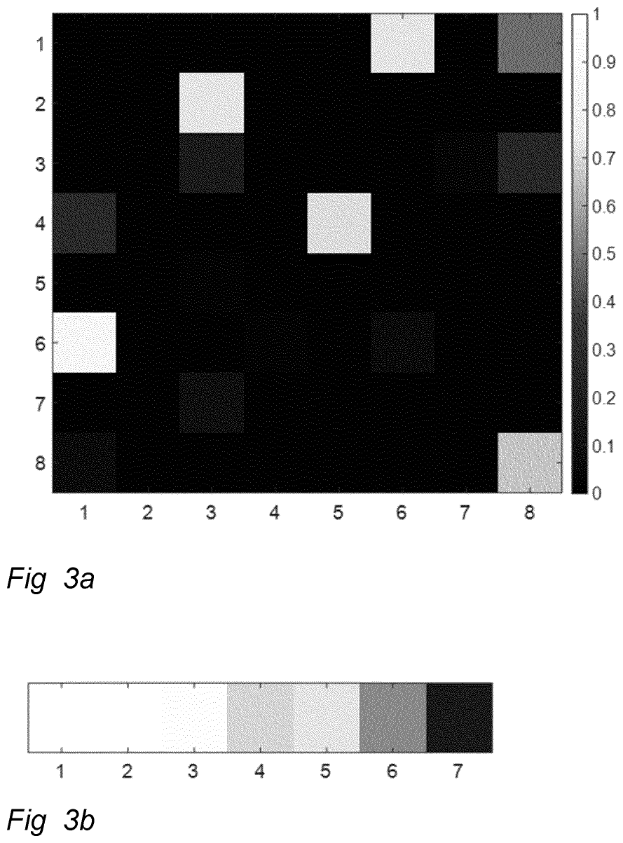

FIG. 1a shows functional units that may be functional units of the processor system. For example, FIG. 1a may be used as a blueprint of a possible functional organization of the processor system. The processor circuit(s) are not shown separate from the units in these figures. For example, the functional units shown in FIGS. 2a or 4a may be wholly or partially implemented in computer instructions that are stored at device 110 and/or system 100, e.g., in an electronic memory of device 110 and/or system 100, and are executable by a microprocessor of device 110 and/or system 100. In hybrid embodiments, functional units are implemented partially in hardware, e.g., as coprocessors, e.g., arithmetic coprocessor configured to execute a concentration function, and partially in software stored and executed on system 100.

In the various embodiments of system 100, the communication interfaces may be selected from various alternatives. For example, the interface may be a network interface to a local or wide area network, e.g., the Internet, a storage interface to an internal or external data storage, a keyboard, an application interface (API), etc.

The systems 100 may have a user interface, which may include well-known elements such as one or more buttons, a keyboard, display, touch screen, etc. The user interface may be arranged for accommodating user interaction for configuring the system to generate a random number or to perform a function that relies on a random number, etc. Storage may be implemented as an electronic memory, say a flash memory, or magnetic memory, say hard disk or the like. Storage may comprise multiple discrete memories together making up storage 140. Storage may comprise a temporary memory, say a RAM. The storage may be cloud storage.

Device 110 is typically implemented in a single device. Having the noise source as a part of the random number generation device is convenient but not necessary. For example, in an embodiment, a random number generation device is created without the sparse noise source, but with an interface to receive a sparse noise source response. Later, e.g., in a further manufacturing stage, such an embodiment can be combined with a sparse noise source. When the random number generation device is combined with the noise source 160, the interface between noise source 160 and the concentration functions of the random number generation device is typically internal to the device, but this is not strictly necessary, as the interface and noise source could be external to the random number generation device. FIG. 1b schematically shows an example of an embodiment of a random number generation device 111 that comprises the sparse noise source 160, and wherein the noise source interface is internal to device 111.

FIG. 1c schematically shows an example of an embodiment of a random number generation device 112. Device 112 comprises a sparse noise source 160, and an entropy processing unit 162. Entropy processing unit 162 comprises computer software and/or circuits to obtain the noise sequence from source 160, and to concentrate the values. Entropy processing unit 162 may provide other functions, e.g., perform tests on the values before and/or after concentration, generate further random numbers from a seed, and the like. Entropy processing unit 162 may interact with a computation unit 170 which may be configured with an application that consumes random values, e.g., for cryptographic purposes. Ideally, unit 170 does not interact with noise source 160. In an embodiment, units 170 and 162 are obtained from different manufacturers though, so that problems may occur. For example, if unit 170 were to clear a memory corresponding to source 160 before unit 162 gains access to it, then entropy would be reduced to zero. There are, however, various countermeasures that unit 162 can take to spot such problems.

A random number generation device may be implemented with a processor system, but a processor system is not needed. FIG. 1d schematically shows an example of an embodiment of a random number generation device 114. Random number generation device 114 in this case is implemented as a digital circuit. The digital circuit could be a non-programmable circuit, e.g., as specified in a hardware design language, e.g., Verilog, or in the form of a netlist. The digital circuit 114 could also be a programmable circuit, in particular an FPGA. The digital circuit 114 may be a hardware module, a sub-module, or an IP block.

In FIG. 1d, the digital circuit 114 is integrated into a larger computing device, thereby imparting the entropy concentrating function on the larger device. In that sense the computing device 113 is also a random number generation device.

Random number generation device 114 is configured with a sparse noise interface. In this example, the sparse noise interface of random number generation device 114 is configured to receive sparse noise data from a sparse noise source 160 comprised in the larger device 113. The sparse noise source 160 could also be external to devices 113 and 114 both. Random number generation device 114 is configured to concentrate entropy in a noise source response sequence as in an embodiment.

Random number generation device 114 may be configured with a state machine. The state machine may be arranged to run through a sequence of states. As the state machine moves from state to state different computation may be computed.

Random number generation device 114 may be configured with a matrix multiplication block to perform a fixed matrix multiplication. A matrix multiplication over bits, e.g., modulo 2, is particularly efficient in hardware. For example, a matrix taking n input bits and m output bits may be implemented as a block of digital gates, having n input lines and m output lines. Each of the output lines may be computed as an XOR operation over a predetermined subset of the input lines. The particular subset being determined by the non-zero elements in the corresponding row or columns of the matrix. In an embodiment, the matrix multiplication block may be applied q times, e.g., to q stretches of memory, each having n bits. The repeated application of the matrix multiplication block may be managed by the state machine. The output may then comprise qm bits, e.g., the concatenation of q outputs of the matrix multiplication block. In another embodiment, the matrix multiplication block may be configurable for a different matrix, e.g., by loading the matrix elements into the block.

For example, device 114 may be a digital circuit which may be manufactured and/or distributed independent of the larger device in which it has been integrated.

For example, processor system 130 may execute a call to block 114. For example, the call may instruct to one or more of: compute or retrieve the concentrated sequence, perform a test on the concentrated or unconcentrated sequence, or to obtain a pseudo-random number from a sequence seeded by the concentrated sequence.

System 100 may be implemented in a single device. Typically, devices 110, 111, 112 each comprise a microprocessor which executes appropriate software stored at the system; for example, that software may have been downloaded and/or stored in a corresponding memory, e.g., a volatile memory such as RAM or a non-volatile memory such as Flash. Alternatively, the systems may, in whole or in part, be implemented in programmable logic, e.g., as field-programmable gate array (FPGA). The systems may be implemented, in whole or in part, as a so-called application-specific integrated circuit (ASIC), e.g., an integrated circuit (IC) customized for their particular use. For example, the circuits may be implemented in CMOS, e.g., using a hardware description language such as Verilog, VHDL, etc. In particular, devices 110, 111, and 112 may comprise circuits for the evaluation of arithmetic.

A processor circuit may be implemented in a distributed fashion, e.g., as multiple sub-processor circuits. A storage may be distributed over multiple distributed sub-storages. Part or all of the memory may be an electronic memory, magnetic memory, etc. For example, the storage may have volatile and a non-volatile part. Part of the storage may be read-only. Devices 110, 111, 112 may, e.g., be a computer, smart card, microcontroller, electronic control unit, set-top box, sensor, mobile device, mobile phone, laptop, PC, server, and so on.

A computer readable medium may comprise data to implement a method according to an embodiment. Such a medium is typically a non-transitory computer readable medium, e.g., an electronic memory, storage device or the like, but may also be a transitory medium, e.g., an electronic signal.

Data to implement an embodiment may be data representing instructions, which when executed by a processor system, cause the processor system to perform a method according to an embodiment. For example, the processor system may comprise a microprocessor configured to execute the instructions. The processor system may comprise or have access to a noise source.

Data to implement an embodiment may be data representing a digital circuit configured to perform a method according to an embodiment. For example, the data may be according to a hardware description language (HDL). A hardware description language is a computer language arranged to describe the structure and behavior of electronic circuits, and in particular, digital logic circuits. For example, the hardware description language may be register-transfer level (RTL) language. In an RTL language one specifies a digital circuit in terms of the flow of digital signals between hardware registers, and the logical operations performed on those signals. The HDL may for example be a language such as Verilog and VHDL. From a description in any of these languages one can derive lower-level representations and wiring.

The data representing a digital circuit may also be a lower-level language, e.g., a netlist.

FIG. 2a schematically shows an example of an embodiment of a random number generation system 200. System 200 may be implemented in one integrated device, or in multiple devices. For example, system 200 may be implemented in system 100 or device 111.

System 200 comprises a sparse noise source 260. Sparse noise source 260 is configured to generate a noise source response sequence of values. Typically, the values are bits, though this is not necessary, and an embodiment could operate on other values, e.g., having four possible values, or sixteen, or more; for example, the values may be bits, nibbles, bytes, or the like. The noise source may in particular be a PUF, although this is not necessary.

A noise source can be regarded as sparse if a large part of the total entropy in the sequence is concentrated in a small part of the sequence elements. For example, a noise source may be regarded as sparse if 90% of the total (noise) min-entropy of the entire sequence is contained in only 50% the samples in the sequence. For example, a noise source may be regarded as sparse if 30% of the total entropy is contained in only 10% the samples.

The noise source may be connected through a sparse noise interface configured to obtain the sparse noise source response from the noise source. FIG. 2a shows noise source response sequence 270 comprising multiple values.

System 200 comprises a matrix storage 210 configured to store a matrix arranged for entropy concentration. The matrix has a different number of columns than rows, which allows a matrix multiplication with such a matrix to have more input values than output values.

Matrix storage 210 may be an electronic memory. Typically, the matrix storage 210 is non-volatile memory for the non-volatile storage of a matrix. For example, system 200 may be configured with a particular matrix, e.g., a matrix with particularly good properties, or a matrix selected specifically for this system 200, or the like. Using non-volatile memory the matrix is retained across power-ups, and can be applied to new responses of the noise source. Matrix storage 210 may comprise volatile storage for storing the matrix. For example, the matrix may be received, or generated, at each new power-up, obviating the need for non-volatile storage of the matrix.

Matrix storage 210 may comprise Read-Only memory (ROM). The matrix may also be hard-coded into the circuitry of a chip, e.g., of an ASIC, SoC or FPGA design. For example, the matrix can be implicitly hard-coded in the implementation, in a digital circuit, e.g., as a particular combination of gates, e.g., XOR-gates, or in a software algorithm, e.g., as a particular sequence of operations, e.g., XOR-operations. This can have efficiency benefits in terms of implementation size and speed.

The matrix may be stored in compressed form. For example, a seed may be stored in storage 210. The seed may be used to generate random numbers, which in turn may be used to generate the matrix. Previously, the seed may have been tested to produce a good matrix. This has the advantage that a random matrix is generated, which may be different on different devices, but which nevertheless requires much less storage. For example, the seed may be 64 bytes, while the matrix may be a larger by a hundred times or more.

In an embodiment, the matrix may be generated on the fly, as needed. For example, the matrix may have a predictable structure suitable for generation. For example, a Reed-Muller parity check matrix can be generated when needed.

System 200 comprises an entropy concentration unit 290 configured to concentrate entropy in the noise source response sequence 270 by computing a matrix multiplication modulo a modulus between the matrix and a vector comprising the values in noise source response sequence 270. In this way, the noise source response sequence 270 is turned into a shorter sequence, while concentrating the entropy. The concentrated sequence 272 comprises fewer values than the sequence of noise source response values.

Typically, the modulus used for matrix multiplication is the same as a modulus associated with the values in the noise source response. For example if the multiple noise source values 270 are bits, then the matrix multiplication is typically done modulo 2. If the noise source values 270 are values modulo M, then the matrix multiplication may also be modulo M. Conveniently, the value M=2 is used, but larger values of M are also possible.

There are various algorithms to compute a matrix multiplication. For example, if a multiplication Mv=c is to be performed, one could compute multiple sums of the form Σₖ₌₁ⁿ mᵢₖvₖ=cₖ; wherein the entries of matrix M and vectors v and c are denoted with mᵢₖ, vₖ and cₖ respectively. The number of these sums depends on the size of M, e.g., the number of rows. Corresponding equations can be written down if one works with a transposed matrix, row vectors or similar variations. To perform the matrix multiplication the sums may be organized in various ways, e.g., parallelized, interleaved and so on.

For example, instead of performing the computation row by row, one can instead iterate over the pairs (i, k). For each pair (i, k) the value mᵢₖvₖ is computed and added to a running total in cₖ; the values cₖ may be initially set to zero. As said, one can generate the pairs (i, k) row by row, but instead one can also iterate through them column by column or block by block.

Various ways of storing the matrix elements lead to different implementations. For example, one could store the entries of the matrix in their entirety. For example, one could only store non-zero elements of the matrix. In the latter case, the non-zero components may be labelled with their location in the matrix, so that the above sums can be computed. As the latter avoids the retrieving of unused matrix elements, this can be more efficient. For example, one can only generate pairs (i, k) for which mᵢₖ≠0, e.g., as indicated in a table or the like.

Further examples of matrix multiplication algorithms that can be adapted to the present situation are given in the paper “Efficient Sparse Matrix-Matrix Multiplication on Multicore Architectures” by Adam Lugowski.

The matrix elements mᵢₖ may be stored together, from which the matrix elements are read to execute the matrix multiplication. The matrix elements mᵢₖ may instead be stored together with the software or digital circuitry that executes the matrix multiplication. For example, the above sum can be hard coded in a series of XOR instructions or XOR gates, or even a combination of the two.

System 200 comprises an optional first test unit 281. First test unit 281 is configured to perform one or more tests, e.g., statistical test(s), on the raw output 270 of the noise source, before concentration. A second test unit 282 is configured to perform one or more tests, e.g., statistical test(s), on the concentrated output 272 of the entropy concentration unit 290. For example, test 281 may focus on health test, spotting malfunctioning of the noise source, while test 282 may focus on entropy, spotting too low entropy for the intended application. In an embodiment, only test 282 are done, while test 281 is omitted.

An advantage of system 200 is that tests performed on the concentrated sequence 272 are more meaningful than tests performed on a sequence concentrated according to the known system, e.g., wherein a cryptographic hash is used to concentrate entropy.

System 200 further comprises an optional application 285. Like noise source 260, also application 285 may be combined with the system at a later stage.

For example, in an embodiment system 200 is implemented in a single device comprising the noise source interface, matrix storage and entropy concentration unit. Said single device may later be combined with noise source 260, test 281, test 282, and/or application 285, either in a single integrated device, or not. For example, an embodiment system 200 is implemented in a software package, e.g., embodied on a transitory or non-transitory computer readable medium. The software package comprising data representing instructions configured for:
obtaining a noise source response sequence of values from a sparse noise source, the sequence comprising both noisy values and non-noisy values, and
retrieving a matrix arranged for entropy concentration, the matrix having a different number of columns than rows, and
concentrating entropy in the noise source response sequence by computing a matrix multiplication modulo a modulus between the matrix and a vector comprising the values in the noise source response sequence, thus obtaining a concentrated sequence of random values, the concentrated sequence comprising fewer values than the sequence of noise source response values. The software package may implement other features, variants, improvements, etc., as described herein.

The sparse noise source may be provided with a sparse noise source interface 265 for reading out the content of the noise source. For example, the interface may be a memory interface, e.g., may comprise a bus, a memory manager, or the like. For example, an interface may be implemented as a function call, e.g., an API, or the like.

The sparse noise source may comprise multiple sparse noise source elements. Each of the multiple sparse noise source elements is configured to produce one value of the noise source response sequence. A sparse noise source is a noise source which, with non-negligible probability, produces occasional samples with very-low or zero entropy. FIG. 2b schematically illustrates an example of an embodiment of multiple sparse noise source elements 261. The multiple sparse noise source elements 261 are represented in FIG. 2b as multiple triangles. Each noise source element is configured to produce one possibly noisy value. Together they produce a sequence of multiple sparse noise source response values 262. Values 262 may be used in FIG. 2a as response 270. The noise source is sparse, so that part of the multiple sparse noise source elements 261 produce a noisy value, but part of the multiple sparse noise source elements produces a fixed value. This is illustrated in FIG. 2a by filling the squares that represent the values 262, as white for high-entropy noisy values, or black as fixed or near-fixed values. For example, FIG. 2c schematically illustrates an example of an embodiment of response sequence of values, in which the values are shaded in gray scales to indicate differences in entropy.

From a single read-out of a sparse noise source, it is not apparent which values are high entropy and which are not. Although some values may be fixed over multiple read-outs, they may still appear random in a single observation. Only when the noise source is repeatedly read out, may one observe that some values are noisy and some are not. Repeatedly reading out the noise source is not convenient or not always possible, as it requires a usable method for repeatedly measuring the noise source, and a large amount of non-volatile memory for keeping track of the high-entropy positions. Moreover, some noise sources, especially some types of PUF sources, only produce new values 270 when they are power-cycled, e.g., powered-down and powered-up again. This makes collecting multiple measurement even less convenient. Furthermore, some devices do not allow power-cycling. For example, some devices are powered-up only once, after which they always remain on, and cannot be power-cycled. For example, a sensor may be powered-up once, after which it will remain powered until and end-off life event, e.g., battery depletion, device failure, device replacement, etc.

The sparse noise source may be a PUF, in particular a PUF constructed from multiple smaller elements. For example, such elements may be memory cells, and the noise source may be a memory PUF. Any memory showing a random start-up behavior which is sufficiently stable for identifying the memory is called a challengeable memory. As the start-up behavior is random, two different memories will have a large difference in their start-up memory pattern; as the startup behavior is stable two start-up memory patterns of the same memory will have a small difference. Salt and pepper noise will exist between two start-up memory patterns of the same memory, which can be concentrated according to an embodiment.

Examples of such memories are SRAM memory cells also memory elements like flip-flops. Actually, any type of volatile memory may be used that comprises feedback loops. A second kind of SRAM based PUFs can be constructed with Dual Port RAM. By writing on both ports at the same time different information, the memory cell is brought into an undefined state and shows a PUF-like behavior. This kind of PUF is described in more detail in WO2009024913. Other so-called Intrinsic PUFs are based on delay phenomena, see, e.g., US20030204743. A PUF may be constructed by simulating an SRAM memory cell on an FPGA, e.g., by cross-coupled invertors or latches, the so-called butterfly PUF see European patent EP2191410 B1 and WO2011018414A2. The PUF may be a buskeeper PUF, comprising a plurality of bus-keepers, e.g., as described in WO2012069545. Coating PUFs are discussed, e.g., in US patent application 20080256600. All the above documents are included herein by reference, especially, e.g., for details regarding their construction and use.

Multiple PUFs, even PUFs of different types can be combined to provide the noise source elements. For example, an SRAM PUF and a buskeeper PUF may be combined. For example, system 200 may comprise multiple sparse noise sources, e.g., multiple PUFs, possibly even PUFs of different types. The multiple sources together provide the noise source response sequence 270. An advantage of combining different noise sources is that they may be resistant to different attack profiles, e.g., different types of physical tampering. Another advantage is that entropy can be collected from different sources and so increase the amount of entropy.

For example, the elements of the multiple elements in the sparse noise source can be forced into one of multiple possible states, e.g., by powering-up the element; for binary elements, the number of possible states is 2. Some of the elements may always go to the same state, but part of the elements may sometime go into different states.

Note that embodiments would work as well if the sparse noise source turns out not to be sparse or not as sparse as expected, e.g., if the noise-source unexpectedly turns out to be a high-density entropy source. In that case, the entropy of the concentrated sequence may be as high or even higher than anticipated, which would not be a problem. It could be a problem though for other applications of the noise source. For example, the stable bits in the noise source may be used for device identification, anti-counterfeiting, or for deriving a reproducible cryptographic key from, typically also using helper data. If the entropy of the noise is too high, then these functions may not work anymore.

In an embodiment, the noise source is a PUF, the response sequence of values being the PUF output, wherein the processor system is configured to derive a cryptographic key and/or a device identifying string from a first part of the PUF output, and to concentrate entropy in the second part of the PUF output. The first part and second may be non-overlapping, overlapping or the same. The first improves the independence between cryptographic key and/or a device identifying string and random values that are produced. The latter reduces the total size of the PUF because at part of the same PUF is used for multiple purposes, e.g., stable ID generation and noise entropy generation. The size of PUFs can be considerable, e.g., the number of cells they comprise.

In an embodiment, two sparse noise source response from the same device differ in fewer than k₂ bit positions out of n bit positions with high probability, say 1-10⁻⁶. For example, one may select a k₂ for which k₂/n<0.2. In an embodiment, the sparse noise source response is sufficiently stable for device identification, e.g., given two devices from a set of distinguishable devices, they differ in more than k₁ bit positions, with high probability, say 1-10⁻⁶. For example, one may select a k₁ for which k₁/n>0.5. On the other hand, k₁/n should also not be much larger than 0.5, since that would mean the two PUFs are actually more similar to each other's inverse than you would expect. For example, one may take: 0.3<k₁/n<0.7

For example, in an embodiment the noise source satisfies 2k₁>n>5k₂ with high probability, for two given sequences of the same or of different devices, as the case may be.

Another way to characterize a sparse noise source, is as a noise source with low entropy per bit. For example, entropy per cell is less than 0.1 bit on average, implying that some samples will have no or very small entropy.

FIG. 2d shows a typical shape of the one-probability distribution density for an SRAM cell. The horizontal axis shows the one-probability (p) of the cell. The vertical axis shows the probability density function, indicating the likelihood of encountering a cell with that one-probability in an SRAM array. Note that on power-up the majority of cells always start up with the same value, as evinced by the peaks of high probability near p=0.0 and p=1.0. At power-up the cell is forced in to one of two possible values. This could be either a one or a zero. Although the pattern of ones and zeros is random, it is consistent in that it is the same on almost all power-ups for all almost-all cells. However, between these extremes there are also cells that are noisier. Some of them will sometimes power-up with one and sometimes with zero. Most of the noisy cells are biased, in that they have a preference for one or zero. The noise entropy contributed by a particular cell with one-probability p can be expressed in terms of min-entropy using the usual definition: h=−log₂(max{p, 1−p}).

Note, that for most cells, a previous measurement very accurately predicts a new measurement, since their one-probabilities are typically close to 0.0 or 1.0. However, for a small portion of cells, the one-probability is not close to 0.0 nor 1.0, and their outcome on the next evaluation of the SRAM PUF has some level of unpredictability, even to a party with the best possible description of how the SRAM PUF behaves.

In other words, these unstable cells cause the so-called noise behavior of the SRAM PUF, and this behavior generates fresh entropy upon every evaluation of the PUF (e.g., an SRAM power-up). This entropy is also called the noise entropy of the PUF. This noise behavior lies at the basis of the noise source, and the corresponding noise entropy level constitutes the entropy harvested.

Other cell based PUFs, including a butterfly PUF or buskeeper PUF show a similar behavior, with the majority of cells having substantially 0 or 1 one-probabilities, and only a part of the cells showing noisy behavior.

Returning to FIG. 2a, entropy concentration unit 290 is configured to concentrate the entropy found in the unstable cells, even though it is not known where these noisy cells are located. Moreover, this is achieved while preserving the possibility of meaningful analysis of the concentrated sequence. If, instead, one were to perform statistical tests on the raw output of a sparse noise source, e.g., on values 270, such tests may very well fail. For example, the statistical tests defined by NIST SP800-90B require that each individual sample produced by the noise source should have a guaranteed lower-bound for its min-entropy. If the noise source produces occasional samples with very low entropy, it will fail some of these statistical tests even for meaningful values of estimated entropy, even if the total collection of produced samples as a whole contains sufficient entropy for the intended application. This problem could be resolved by applying a concentration function such as SHA-256 as in the known PUF random number generator, but this would create the opposite problem. Due to the cryptographic nature of a hash function, the resulting output will look random to most if not all statistical tests.

This creates the dilemma, that the raw output of a sparse noise source, such as a PUF, should neither be directly used as random bits, but should not be concentrated with conventional cryptographic hash functions either. Note that processing options, such as, e.g., preselecting only the noisy bit positions and discarding the stable ones, will not work either since the locations of the noisy bits in an array are random and a-priori unknown.

Using a linear matrix multiplication for entropy concentration of a sparse noise source has the advantage that this entropy concentrating function to a large extent preserves the statistical properties of its input, allowing for meaningful entropy estimation and statistical testing on its output, e.g., in compliance with the NIST SP800-90B. The entropy concentrating function can be applied directly to noise source output, e.g., PUF output. The entropy concentrating function transforms the diluted and sparse noise entropy into a more highly concentrated noise entropy output at certain bit positions. Many matrices have these properties; however it will be discussed below that parity check matrices of error-correcting block codes are particularly efficient in this entropy concentration function.

In an embodiment, the entropy concentrating function is a syndrome computation for an error correcting code. Syndrome computation is normally done by a matrix multiplication with a parity check matrix, but any equivalent algorithm for computing the syndrome could be used.

The matrix will typically comprise bits, and the matrix multiplication will be done modulo 2. But other moduli and alphabets could be used instead. For example, an advantage of using a higher modulus M, e.g., a modulus larger than 2, is that it can be used to accommodate naturally a noisy source that produces values that have a larger domain than 2. An example, using a higher modulus M, is that one has a wider choice of parity check matrices to choose from, as more error correcting codes are available.

The matrix has a different number of columns than rows. This means that the matrix may be used in a matrix computation with a longer input vector than output vector. Part of the output values will depend on multiple input bits, thus concentrating the entropy in the input bits. At the same time, the concentrated sequence will comprise fewer values than the sequence of noise source response values. In an embodiment, the matrix is substantially rectangular, for example, the larger of the column and row size may be at least 2 times the smaller of the column and row size, or even 4 times larger. For example, in an embodiment, the larger number is between 2 and 20 times the smaller number, i.e., at least 2 times and at most 20 times. For example, in an embodiment, the larger number is between 4 and 10 times the smaller number, i.e., at least 4 times and at most 10 times. These ranges are advantageous, because on the one hand they provide a decent compression factor to remove low-entropy bits, but on the other hand, they are not too high, or else one would get too few output bits.

Note that the dimensions of the matrix determine whether the matrix multiplication is a right or left multiplication or whether the matrix is transposed or not.

Experiments showed various ways to constrain the matrix used for entropy concentration. The constraints that are used for a particular sparse noise source depends on the source's parameters.

For example, one may require that the larger number is at least 64, at least 128, or at least 1024, etc. Using more input bits has the advantage that the probability of capturing a sufficient number of unstable cells is higher. On the other hand, the smaller number of the column and row size, is preferably not too small, as these lose too much of the entropy in the input. For example, one may take the smaller number at least 4, at least 64, or at least 128.

As the matrix is rectangular, it is not possible for all rows and all columns to be linearly independent. However, if the number of rows of the matrix is smaller than the number of columns then preferably the rows are linearly independent, or vice versa. Using linearly independent rows avoids that bits in the output have a linear dependence amongst themselves, which would lower entropy in the concentrated sequence.

The elements in the matrix determine on which input values an output value depends. Preferably, the matrix is selected so that any two output cells derive from at least one or more different input cells. One way to ensure this is to choose the rows (if the number of rows is the smaller one) to have a large hamming distance from each other (or vice versa if the number of columns is the smaller one). Comparing two rows, then a particular position in these two rows contributes one to the hamming distance if one row has a 1 and the other row has a zero; that is if one of the output cells is dependent on that position but the other cell is not. Depending on the prevalence of unstable cells, one can insist on a minimum value for the hamming distance. For example, in an embodiment, and any two rows have a hamming distance of at least 64, at least 128, or at least 10% of the length of the row.

Even more precisely, given two rows r₁ and r₂ one can compute an asymmetric hamming distance between the rows. The first hamming distance H₁ counts the number of positions in which r₁ has a one but r₂ has a zero; The second hamming distance H₂ counts the number of positions in which r₁ has a zero but r₂ has a one. The conventional Hamming distance H is the sum of the two asymmetric distances; H=H₁+H₂. A high asymmetric Hamming distance is advantageous, as it means that a particular row depends on cells that the other row does not depend on. In an embodiment, for any two rows both asymmetric Hamming distances is above a threshold. The threshold can be chosen for example, such that the probability of having a certain number, e.g., one or more, unstable cells among the selected cells in a row is higher than a threshold. For example, in an embodiment the threshold may be at least 32 or at least 64, etc., or at least 5% of the length of the row. If the number of columns is the smaller one, than the situation reverses, e.g., imposing limits on the asymmetric Hamming distance between columns.

Furthermore, it is desirable that rows have some overlap, that is some locations where they both have a one. Considering the two rows, consider H₃ which counts the number of positions where both rows have a 1. If H₃ is too low, the rows become too independent. This means that concentration may be higher than needed. For example, one may require that H₃ is also above a threshold. For example, in an embodiment the threshold may be at least 32 or at least 64, etc., or at least 5% of the length of the row.

In an embodiment, all of H₁, H₂, H₃ are above a threshold, e.g., all above 5% of the length of the row, for substantially all, or all, pairs of rows. Having overlapping 1's between rows improves efficiency. When there is little overlap between rows some of the entropy of the input will be lost, so that more input bits are needed to retain sufficient entropy in the output.

As PUF can be well characterized, e.g., for an SRAM PUF, e.g., the distribution of the one-bias can be well approximated, these bounds can be computed analytically, and the likelihood that they are or are not satisfied. These bounds can also be verified empirically, e.g., by testing on physical instantiations of the PUF in question.

The matrix is arranged to concentrate the entropy in the input. For example, in an embodiment, the entropy in the concentrated sequence is at least 80% of the entropy in the noise source response sequence, preferably at least 90%, more preferably at least 95%. Estimating the entropy preservation of the matrix may be done by modelling the noise source input. For example, in an embodiment, one may model PUF cells as independently distributed cells having a particular one-probability. The one-probability may itself be normally distributed. Details can be found in the paper “An Accurate Probabilistic Reliability Model for Silicon PUFs”, by Roel Maes, included herein by reference. The entropy of the input vector and output vector can be computed mathematically using the model. The resulting reduction in entropy can then be computed. For example, a given PUF, e.g., SRAM can be measured multiple times, and the parameters of a particular PUF model, e.g., as in the above paper, can then be estimated, e.g., using a maximum likelihood estimator.

If the matrix is not binary, then the above criteria may be replaced with 0 versus non-zero instead of 0 versus 1. If the number of columns is the smaller one, then criteria for rows and columns may be reversed.

There are several ways to generate the matrix. For example, the matrix may be randomly generated. For example, the dimensions of the matrix may be predetermined, and the matrix may then be randomly filled. For example, if needed one may repeatedly generate a random until a matrix is obtained satisfying any conditions set up on it. For example, the elements of the matrix may be filled independently according to a Bernoulli distribution, e.g., with a probability of p. For example, in an embodiment p may be taken as ½ or as ⅛, etc., e.g., between 0.1 and 0.5.

The matrix may be provisioned on the random number generation device. For example, during manufacture or personalization of the device, the matrix may be stored at the device. In an embodiment, the matrix is fixed and the same for multiple devices. This may be done, for example, in case an optimized matrix is used. Another option is to provide a different matrix to different devices. This may be done, e.g., if the matrix is randomly generated. In case of a flaw in a matrix it is an advantage that the matrix is only provided to one or few devices rather than a whole batch. Generating the matrix, either randomly or not, is also advantageous to avoid random number generation during the matrix generation on the device.

Yet a further way to provision the matrix is to generate it on the device, this may be on the fly, e.g., at each power-up of the device, this may also be done once and non-volatile stored. Avoiding non-volatile memory can be an advantage for some devices though, e.g., low resource devices, e.g., sensor devices. A disadvantage of random generation of the matrix on the device is that it takes time and randomness. The latter may be available, e.g., by applying a conventional concentration function, e.g., a hash function, to a noisy source output. The resulting values may be used as a seed, which in turn can be used to generate the matrix. This has the advantage of local generation. Generating the needed randomness using a hash function has the disadvantage that the randomness of the matrix will be hard to analyze. However, these numbers will not be used in an application, e.g., a cryptographic application, so that this is not as severe a problem as a lack of analyzability would be in the concentrated sequence.

Denoting the matrix with H, and the input with x and the output with y, the matrix product may be written as y:=xH^{T}. This type of concentration has the following advantages:
The linear matrix product y:=xH^{T} over GF(2) means in practice that each bit of the output block y is the result of an exclusive-or (XOR) operation over a selection of bit positions from the input block x, specifically, those positions in the input block where the corresponding row of H has a 1-value. The XOR-operation is known to preserve randomness, i.e., the (min-)entropy of its result is at least as high as the highest (min-)entropy of its (independent) inputs.
If H has full rank, the bits of y are linearly independent; i.e., no bit of y can be systematically expressed as a linear combination (XOR) of other bits of y.
On the other hand, for a specific matrix, the transform as a whole is a simple and straightforward linear operation. It is fully stateless and involves no secret parameters, no secret inputs, no additional (pseudo)random sources, no pseudo-random(-like) functions, and no one-way(-like) operations. The transform does not generate any form of ‘pseudo’-randomness, nor does it obfuscate a lack of entropy in the input.

A pointed out above, the matrix may be generated randomly, possibly enforcing some conditions, e.g., on the amount of compression, the distance between the rows or columns and the like. It is also possible, to make a determined choice for the matrix. A particularly advantageous choice for the matrix is to take a so-called parity check matrix of a linear block code. In particular, the parity check matrix of a Reed-Muller code, typically a binary Reed-Muller code. Other suitable linear codes include parity check codes, Hamming codes, BCH codes, Reed-Solomon Codes, LDPC, Golay codes, LDPC, etc. Conventionally, in the field of error correcting, a parity matrix is used to compute the syndrome of a received word, in this case however, the parity matrix is used to concentrate entropy in a larger input vector in a smaller output vector. An advantage of using such error correcting codes, is that some input bits are used in more than one output bits thus increasing the efficiency; preferably, one has for an (n, k, d) code that n<kd.

As an example, entropy concentration using a Reed-Muller code may be done as follows.
1. Let H be the parity-check matrix of RM(r, m), the binary Reed-Muller code of length 2^{m} and order r
   a. the size of H is (n−k)×n with n=2^{m} and k=Σᵢ₌₀^{r}(ᵢ^{m})
   b. since the dual code of RM(r, m) is RM(m−r−1, m), H can also be considered as the generator matrix of the RM(m−r−1, m) code.
2. Let x be an n-bit binary vector of PUF response data generated by the evaluation of n different cells. Compute y:=xH^{T}, i.e., the linear matrix product of x with H^{T} computed over GF(2)
   a. the resulting size of y will be (n−k) bits.
   b. with respect to the RM(r, m) code, y represents the syndrome of x.

If more than (n−k) concentrated bits are needed, then one may apply the linear matrix transformation applied on q non-overlapping n-bit vectors of the PUF response data, resulting in q consecutive (n−k)-bit syndrome vectors. The final sequence of q syndrome vectors, of size (n−k)-bits each, is interpreted as a raw data output stream of q(n−k) binary noise samples.

The transformation is determined by the parameters (r, m) of the selected Reed-Muller code, and q, the number of consecutive processed n-bit PUF response data vectors, and can be adapted to the case at hand. As with other matrices, the choice of parameters can be restricted by considerations on the dimensions of the matrix and on relationships between columns or rows as discussed herein. In an embodiment, one could take, say, 4≤m≤16. The parameter r may be, say, r≥5, or r≥m/2. Parity check matrices for Reed-Muller codes can be generated on the fly.

Using the syndrome computation of an error correcting code as an entropy concentrating transform, in particular of a Reed-Muller code, has a number of advantages. For example, for an (r, m) Reed-Muller code, the rows of its parity-check matrix H are constructed in such a way that:
the Hamming weight of each row is of the form 2^{m-i} for i=0 . . . m−r−1; in particular, H has precisely (ᵢ^{m}) rows of Hamming weight 2^{m-i}.
the minimum Hamming weight of a single row of H is hence 2^{r+1}.
the minimum Hamming distance between a pair of rows of H is also 2^{r+1} this is a special property of the Reed-Muller code.
Reed-Muller codes are in fact the optimal linear transform with these properties.

In other words:
Each output bit of the proposed transform is the XOR-accumulation of a selection of at least 2^{r+1} (or more) input bit positions.
The selections of input bits accumulating in different output bits are not non-overlapping (hence they are overlapping), but for each pair of output bits, one of the output bits will have in its XOR-accumulation at least 2^{r+1} input bits which do not contribute to the other output bit.

These properties give the Reed-Muller syndrome computation the desired qualities for an entropy concentrating transform for the sparsely distributed entropy in the SRAM PUF response. In particular for larger values of r (e.g., r≥5), it follows that:
Each output bit will contain accumulated entropy from at least 2^{r+1} input bit positions (e.g., ≥64 for r≥5). Even for sparsely and randomly positioned entropy-contributing cells, there are with high likelihood at least a few cells in that range which contribute a non-negligible amount of entropy to each output bit. Hence, each generated output bit will, with high probability, have a significant amount of accumulated entropy.
For each pair of output bits, the accumulated selections differ by at least 2^{r+1} input bit positions (e.g., ≥64 for r≥5). Hence, even for sparsely and randomly positioned entropy-contributing cells, with high probability the entropy accumulated in each output bit differs significantly from all other output bits.

The selection of the used Reed-Muller code parameters (r, m) will be defining for its properties as an entropy concentrating transform. As noted above, a sufficiently high value for r is needed to ensure a sufficiently large accumulation size for each output bit, and a sufficient accumulation distance between output bits. Since m≥r, the choice for m is also limited by this, and in addition the choice for m also determines the computational and memory complexity of the transform, since the input block size scales exponentially with m.

The table below lists a number of meaningful selections for (r, m) and the resulting properties of the transform. In the end, the appropriate parameter choice will be guided by the distribution of the input bits. For an SRAM PUF with a relative high number of unstable cells, the minimum accumulation size can be kept relatively small (e.g., 64), and the compression ratio can be relaxed. An SRAM PUF with a small number of very sparsely distributed unstable cells requires a large accumulation size (e.g., 256 or more), and a strong compression.

TABLE 1
meaningful (r, m) selections for the Reed-Muller syndrome computation

| | | | | compression | |
|---|---|---|---|---|---|
| | | | | ratio | min. |
| r | m | input block size n = 2^{m} | output block size (n − k) | $ρ = \frac{n - k}{n}$ | accumulation size/distance 2^{r+1} |
| 5 | 7 | 128 | 8 | 6.25% | 64 |
| 5 | 8 | 256 | 37 | 14.45% | 64 |
| 5 | 9 | 512 | 130 | 25.39% | 64 |
| 6 | 8 | 256 | 9 | 3.25% | 128 |
| 6 | 9 | 512 | 46 | 8.98% | 128 |
| 6 | 10 | 1024 | 176 | 17.19% | 128 |
| 7 | 9 | 512 | 10 | 1.95% | 256 |
| 7 | 10 | 1024 | 56 | 5.47% | 256 |
| 7 | 11 | 2048 | 232 | 11.33% | 256 |

The above table shows linear error correcting codes, wherein the compression ratio is between 1.95% and 25.39%. The above table shows linear error correcting codes, wherein the minimum accumulation size/distance is between 64 and 256 bits. The minimum accumulation size/distance is the minimum number of input cells that are combined into a single output bit, that is the minimum number of ones in a single row. This is preferably sufficiently high to ensure that each output bit has in its input range at least one, and preferably more, noisy cells; if not, the output bit would still be stable.

Entropy concentration may be done multiple times. For example, in an embodiment using a Reed-Muller parity check matrix, the dimensions of the matrix may be, say, 1024×176. Using a sparse noisy source, say a PUF, say an SRAM PUF, having 2048 cells, one may obtain 348 concentrated bits by applying the matrix twice, to two non-overlapping sets of 1024 cells each.

The quality of the random number can be monitored if desired. System 200 shows two optional test units: test unit 281 operating on raw, unconcentrated sequence given by the noisy source, and test unit 282 operating on the concentrated sequence. These are optional, and one may opt not to have them, or to delete them once the tests have been passed. Test 282 may comprise conventional statistical tests, e.g., as defined as ‘health tests’ in NIST SP800-90B. Because of the nature of the concentration function, these tests can be meaningfully applied.

Interestingly, also on the raw sequence one or more tests may be performed. The goal of such a test 281 is to detect catastrophic failures of the underlying noise source, e.g., situations where the noise source stops producing entropy, or the entropy rate is significantly lower than the validated estimate. Preferably, the health tests should be designed and calibrated in such a way that they never fail under normal operation of the noise source, e.g., they should have a small false-positive rate. The false-positive rate can be estimated mathematically from a model of the noise source. Examples of tests that unit 281 may perform include, testing for an all one pattern, an all zero pattern, a repetition or extreme one or zero-bias, e.g., above a threshold. For example, a common fault mode is one in which the device inadvertently clears the SRAM PUF memory after boot-up, e.g., writes it with all zeros.

Below two further advantageous tests are described, that apply to memory based PUF, in particular volatile memory. The typical example of a memory based PUF is an SRAM PUF, though other options are possible, e.g., a DRAM PUF.

The first check validates whether the SRAM PUF used as noise source is in fact a RAM, as opposed to e.g., a ROM, and that it does not have defective stuck-at cells. It may happen in practice that a random generation device is not configured correctly, e.g., by configuring a library with the wrong memory range. This test can advantageously spot this problem. In an embodiment, a first value is read from a particular address of a memory allocated as a PUF noise source, typically SRAM memory, a second value is written to the particular address and read back from it, if the read back value equals the second value, then the test passes. The first value can then be written back to the memory. For example, the test may be done for multiple addresses, or all addresses. The test may be done multiple times for different second values. For example, in a particular embodiment, one may perform the following test for one or more, or all, of the addresses in the memory range:
1. Read the word value at that address and store it in a temporary register.
2. Write the all-zeroes word to that address.
3. Read back the word value at that address and verify that the read word is all-zeroes.
   a. If not, signal a failure.
4. Write the all-ones word to that address.
5. Read back the word value at that address and verify that the read word is all-ones.
   a. If not, signal a failure.
6. Write back the original word value from the temporary register to the SRAM address.

The test may be done before other uses of the memory are made; in particular before the values are concentrated.

Another test that may be done by test unit 281, e.g., on the raw data is the following. In another case of misconfiguration, the memory may be configured for other uses than PUF use. In particular, the memory should not have been used before as an entropy source, possibly in the same process, e.g., before the last system reset. Since the content of the memory is de facto random and rereadable, when it is untouched, there is no inherent indicator telling whether the entropy of its power-up noise was already harvested before. The check below introduces such an explicit indicator.

This check validates that the SRAM PUF allocated for use as a noise source is in a correct state to be used as a noise source. This check verifies that the allocated SRAM PUF was not inadvertently used before without a fresh regeneration of its noise entropy. This check may be performed after previous test, but prior to any other use of the SRAM PUF, or in some other order. In an embodiment, a part of the memory range is read out and compared to an expected sequence, if the part is the same as the expected sequence, the test fails. If the test does not fail, then the memory range is used as an input for entropy concentration. After the first part is used an expected sequence, possibly the same sequence, is written to the first part.

In an embodiment, this check may be as follows:
1. In the SRAM address range allocated to be used as an SRAM PUF, a sufficiently long subrange (e.g., 16 bytes) is allocated for storing a unique state vector. This could be overlapping the actual processed SRAM PUF response range, or it could be an additional and/or dedicated separate range in the SRAM adjacent to the SRAM PUF response range (e.g., making the allocated SRAM range a bit longer than what is actually required for the noise source).
2. Prior to using the data in the SRAM PUF response range as an SRAM PUF noise source, the value in the state subrange is read and compared against an expected sequence, e.g., a list of known state vector values. If a state vector value is observed which indicates that the SRAM PUF noise source was already used before, the check signals a failure.
3. During and after processing of the SRAM PUF noise source by the entropy source, the state subrange is updated with state vectors indicating the state of the processing. State vectors are unique and sufficiently long vectors which are unlikely to collide with an actual SRAM PUF response (e.g., state vectors can be sufficiently long magic words). A state vector may be written to indicate that the SRAM PUF noise source was processed into noise source samples, preferably before these samples are output by the noise source. Other state vectors may also be used.

For example, a state vector may be a predetermined string of, say, 64 bytes, written in the range, say, at a fixed location. For example, the beginning and/or end of the range. The string may be selected randomly at some point but remain fixed thereafter. The string may also contain a non-fixed part, e.g., indicating a time when the memory was last used.

Preferably, no other process, by the entropy concentration unit 290 or otherwise, shall write to the subrange used to write a state vector. The only process which can ‘reset’ the state subrange is a repower of the SRAM, which refills the state subrange with its random power-up state.

Note that for a typical implementation of SRAM in a digital chip, only a reset (soft or hard) without a repower will typically not reset the SRAM contents with new random contents.

At the same time and by the same process, the rest of the SRAM including the range allocated to be used as an analog noise source is also refilled with a new random power-up state which contains fresh noise entropy. Since the random power-up state in the state subrange is with high likelihood not detected as a valid state vector for the analog noise source, the check passes and allows the noise source to be used.

Test unit 281 may also do one or more tests relating to the entropy of the noise source response 270. For example, a test may be done for extreme bias, either in the one direction or the zero direction. This may point to extreme operating conditions, or the like. However, as the noise is sparse, the raw data is less suitable for analysis. Such tests may be omitted. In an embodiment, test 281 performs one or both of the write test, and state-vector test.

Once the concentrated sequence has been generated, they can be used for various purposes that need random numbers. For example, a GetEntropy function may be defined using the sparse noise source, e.g., an SRAM PUF-based entropy source. The function GetEntropy( ) may return the concentrated sequence, and possibly other information, e.g., a status, e.g., an error status (or lack thereof). For example, a GetEntropy function may be implemented as follows:
1. Read the qn noise source response bits from the noise source (e.g., from an assigned SRAM range used as SRAM PUF). Herein q is the number of memory blocks used, that are each n bits long.
2. Apply all defined PUF response health tests on these qn bits (if any). If any of these tests fails, do not return an entropy string. The status may report the error. These tests may be done by test unit 281.
3. Apply the entropy concentrating transform on the full qn bits to generate q(n−k) noise sample bits; these may be kept in an internal buffer NoiseSampleBuffer. For example, q matrix multiplication may be performed, e.g., on q non-overlapping, e.g., consecutive sets of noise source values.
4. Apply all defined noise sample health tests on the q(n-k) bits. If any of these tests fails, clear the NoiseSampleBuffer and return with an error status. These tests may be performed by test unit 282. Following these steps the assigned SRAM range may be zeroized, or a state vector may be written to it, etc.
5. Return the concentrated sequence, e.g., the NoiseSampleBuffer, and a non-error status.

Test unit 282 is optional and may perform tests on the concentrated sequence; typically, these tests include statistical tests. Examples of appropriate test include the ‘repetition count test’ and ‘adaptive proportion test’. These tests are called ‘health tests’ in NIST SP800-90B. For example, such statistical test may be executed every time the entropy source is used. Other statistical tests that may be used include the monobit test, poker test, and the runs test. For example, Fips 140-3, included herein by reference, provides descriptions for these tests. The margins for these tests may be adapted to the number of available bits, to change the false positive/false negative rates, etc. Many other random number tests are available, and may be used in test unit 282. For example, one might use an entropy estimation, and, e.g., require that the entropy is above a lower bound.

The GetEntropy function described above may provide useful randomness only once, e.g., if the source is not re-usable. If more randomness is needed, and the noise source cannot be reused, as may be the case for memory based PUFs lacking a power-cycle, the concentrated entropy may be added to a so-called entropy pool or may be used as the seed for a deterministic random number generation. For example, when adding new entropy to a pool, a mixing function may be applied taking as input the existing content of the entropy pool and the new entropy, e.g., the concentrated entropy and which produces a new entropy pool content. To obtain random numbers, an extraction function may be called, taking as input the entropy pool and producing as output a random number and an updated entropy pool. Note that both the functions used for the entropy pool or for a deterministic random number generator may be non-linear. This is not a problem. Although the entropy concentration used to obtain the concentrated sequence is linear, once tests are performed on them, and the sequence is found to be sufficiently random, non-linear functions can be applied.

System 200 may comprise a further application, e.g., in application unit 285. The application may be configured with software that uses randomness for its operations. An important class of such applications are applications that perform a cryptographic protocol with an external device or a cryptographic algorithm which need a random element. The random element is generated from the concentrated sequence. For example, the cryptographic algorithm may comprise a deterministic random number generator, e.g., a deterministic random bit generator (DRBG). For example, the cryptographic algorithm may be configured to generate cryptographic key generation.

In an embodiment, the sparse noise source comprises a physically unclonable function, and the processor system is configured to
generate a cryptographic key from the concentrated sequence,
compute helper data for the cryptographic key with respect to a physically unclonable function response obtained from the physically unclonable function, the helper data allowing later reconstruction of the cryptographic key from a noisy regeneration of the physically unclonable function response,
storing the helper data.

Non-cryptographic applications are possible, e.g., a simulation application may consume random numbers.

Returning to the embodiment described herein, using a parity check matrix of an error correcting code, in this case a Reed-Muller code.

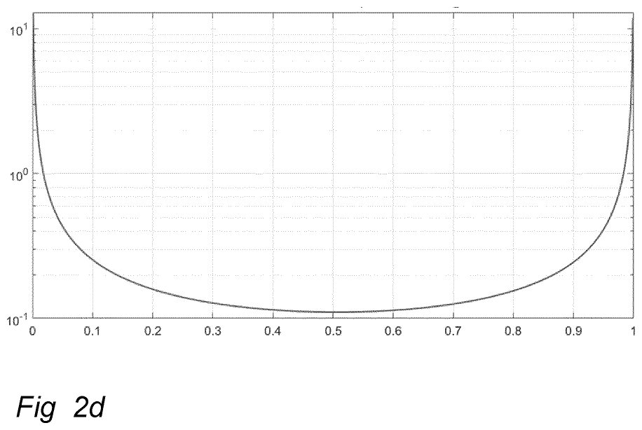

FIG. 3a schematically illustrates an example of an embodiment of response sequence of values. FIG. 3b schematically illustrates an example of an embodiment of a concentrated sequence of values.

FIGS. 3a and 3b are obtained by simulating a 64 bit SRAM, e.g., using model parameters obtained by experiment. Accordingly, exact entropy values can be computed. FIGS. 3a and 3b show an example applied to 64 bits of noisy source response values. Per-bit noise entropy contribution is shown for 64 noise source response values arranged in an 8×8 array, which are in this example bits. The entropy of each bit is indicated by its color intensity, with bright/white squares indicating high/full entropy for that bit, and dark/black squares indicating low/zero entropy for that bit. The summed entropy of the 64 bits shown is 5.2 bits of entropy. These bits are the input to a concentration step.

FIGS. 3a and 3b demonstrates an example of this embodiment for a single block (q=1) with the transform based on the RM(r=4, m=6) code, hence transforming an input block of n=64 bits into an output block of (n−k)=7 bits. Each of the 64 squares corresponds with a cell of a PUF, in this case an SRAM PUF. The 64-bit input block (shown on the left) has an overall summed entropy of 5.2 bit which is randomly and sparsely distributed over the 64 bits. The light squares correspond to unstable cells, having high entropy, while the dark squares are fixed or nearly fixed, having little entropy. Note that FIG. 3a does not show the actual values that are read out. Moreover, in an actual read-out one would not know which cells contribute to entropy and which are fixed or mostly fixed. The 64 read bits would look like a 64 bit sample drawn from a p=½ Bernoulli distribution. Creating a figure such as in FIG. 3a would require repeated power-up to determine the stable and unstable bits.

It can be observed that most of the 64 bits contribute virtually no entropy (black), whereas a small and randomly positioned minority of the 64 bits carries most of the entropy. After the transform, the 7-bit result has an overall entropy of 5.1 bit, hence the majority of the entropy in the input (˜97.5%) is maintained in the output. However, the output is significantly shorter, so the entropy is much more concentrated. FIG. 3b shows the 7 output bits together with their entropy. It can also be observed that in the output block the entropy is more concentrated in the first few positions (bits 1-2-3) and on average decreases in the consecutive bits. This is because the bits in an SRAM PUF are independent of each other, and FIG. 3a shows the per-cell entropy independent of all other bits. In FIG. 3b, however cell number i shows entropy for cell i conditional on the known values of cells 1 to (i−1). For example, knowing output bits 1-6 and knowing the matrix H used for concentration, bit 7 can be estimated, and so contains little entropy. It can be seen in FIG. 3b, that the first three bits have almost full entropy, and that entropy starts to decrease with the fourth bit.

In this case a Reed-Muller parity check matrix is used with parameters r=4 and m=6. The parity check matrix H has dimension 7×64. The input is a 64 bit long vector. The output, e.g., the result of the matrix multiplication between H and the input vector is a 7 bit long vector. One can write this as output_{1×7}=input_{1×64}H^{T}. Note that almost all of the entropy in the input sequence is retained in a much shorter output sequence, without having to use a non-linear function such as a cryptographic hash function.

The process may be repeated on a next block of 64 bits, to obtain a next concentrated sequence of 7 bits. For example, in this way, e.g., 1 kB of SRAM can be converted into 1024× 8/64×7=896 concentrated bits (112 bytes); assuming the above parameters, these bits would contain 652 bits of entropy.

Test 282 may be performed on the 896 concentrated bits. Once test 282 is passed, the concentrated bits, in this case the 112 bytes, may be used directly, e.g., to create a key or the like, but they may also be further processed using a non-linear function, e.g., a conditioning function according to in NIST SP800-90B. For example, the concentrated sequence may be hashed, e.g., with a cryptographic hash, to obtain further concentrated sequence. The latter cannot be usefully analyzed anymore, but as the concentrated sequence has been tested, this is not a problem. For example, in an embodiment, the processor system is configured to concentrate entropy in the noise source response sequence to obtain a first concentrated sequence of random values using a first concentration function. The first concentration function comprises a matrix multiplication. The first concentrated sequence is further processed by applying a second concentration function to obtain a second concentrated sequence of random values. The second concentration function comprises a non-linear function, e.g., a cryptographic hash function; if the hash generates too many values, the sequence may be cut. For example, the second sequence may be used as a seed for a deterministic random bit generator. For example, the second sequence may be used as a cryptographic key. For example, a test 282 may be performed on the first concentrated sequence.

If the entropy in the input is much lower, a larger matrix H may be used. For example, a 176×1024 matrix H concentrates 1024 input values into 176 output bits. Suppose this block is applied q=16 times, on a total of 16×1024=16384 input bits=2kByte, resulting in 16×176=2816 output bits=352 bytes. Assuming the total expected entropy of the input bits is very low, e.g., only 2.4%, or about 2.4%*16384=400 bits then the total expected entropy of the output bits is 90% of the input entropy, i.e. 90%*400=360 bits. The entropy density has increased from 2.4% in the input bits to 12.8% in the output bits. The entropy density has thus increased 5 fold, without using non-linear operations. Statistical tests may be performed on the concentrated sequence. If a higher entropy concentration is desired before doing a statistical test a further linear entropy concentration, e.g., a matrix multiplication, can be performed. After the statistical test further entropy concentration can be done, e.g., an entropy concentration according to an embodiment, or a non-linear hash function may be applied.

FIG. 4a schematically shows an example of an embodiment of a matrix generation system 300. System 300 is entirely optional. That is, good embodiments can be created with good concentration matrices without using a matrix generation system. System 300 may be integrated with a system 200 or may operate external to it.

Generation system 300 comprises a sparse noise interface 365. This may be the same as sparse noise interface 265, e.g., if system 300 is integrated, but it may also be a different interface, e.g., if system 300 is external. System 300 receives at interface 365 multiple noise source response sequences 370, e.g., multiple read-outs of a noise source 260. Shown are a noise source response sequence 371-373. For example, at least 5, at least 10, at least 100 sequences may be collected. Collecting the sequences may be done in a dedicated series of measurements, or they may happen during normal operation.

System 300 comprises a matrix generation unit 360, which is configured to obtain an updated matrix with improved entropy concentration from the multiple noise source response sequences, and to store the updated matrix in the matrix storage 210. The updated matrix may be used for entropy concentration on a new noise source response sequence.

For example, matrix generation unit 360 may be configured to determine the stable bits in the response, e.g., bits that have a one-bias or zero-bias above a threshold. These bits may be discarded from consideration. Corresponding elements in the matrix may be set to zero so that no output bits depend on these stable cells. The unstable cells may be assigned to the different output bits. For example, each unstable cell may be assigned to a number k of output bits. The bits may be selected randomly or according to a predetermined pattern. The pattern may be generated deterministically randomly, e.g., using a fixed seed.

The matrix generation unit 360 may also select an appropriate error correcting code and use for the new matrix. For example, assuming that n of input bits are found to be unstable, while a desired number of outputs bits is m. In that case an error correcting code can be selected with code words of length n and dimension m. For example, a selection criterion may be to select an error correcting code with a high or the highest minimum distance. Other or additional criteria may include those given herein. For example, one may use error correction code libraries.

Note that excluding cells with low entropy as is done by system 300 does not and cannot increase the entropy contained in a sample of the noise source. However, it is possible to distribute the cells that do have entropy better over the output cells, thus decreasing their interdependency, and retaining more of the entropy. For example, if by chance few unstable cells are available at the start of the unconcentrated sequence, then cells that happen to draw more cells from this part may have a higher dependency than desired. By explicitly distributing the known unstable cells over the output cells this is avoided.

FIG. 4b schematically shows an example of an embodiment of a matrix generation system 301 comprising a random number generation device 310 and a configuration device 320. Random number generation device 310 comprises the noise source 260 and reports multiple measured sequences to the configuration device 320, which is external to device 310. Configuration device 320 uses a matrix generation system to compute a matrix for device 310 and stored it in its matrix storage 210. For example, this may be done during use of device 310, but also during personalization of device 310.

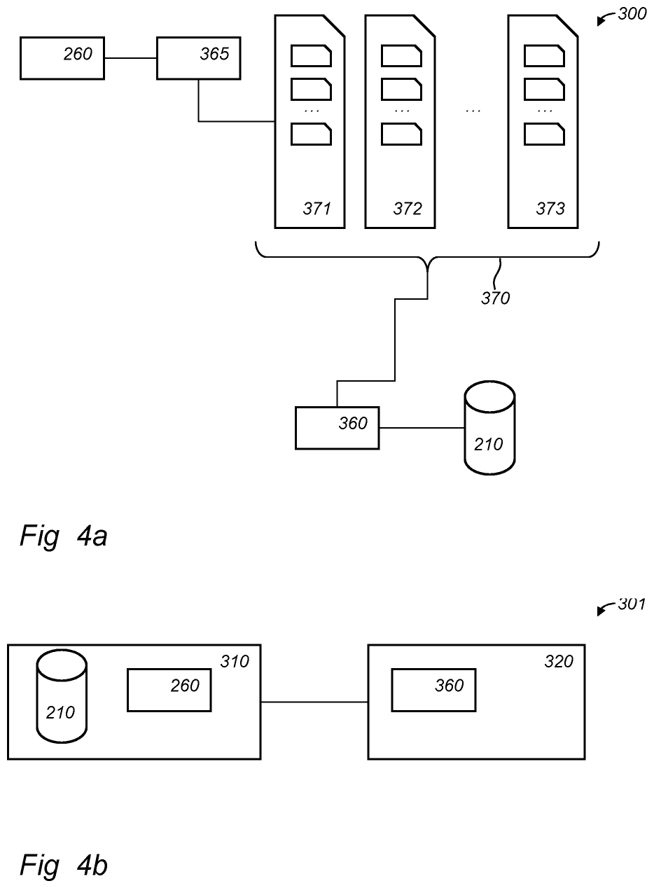

FIG. 5 schematically shows an example of an embodiment of a random number generation method (500). Method 500 may be computer implemented and comprises
obtaining (510) a noise source response sequence of values from a sparse noise source, the sequence comprising both noisy values and non-noisy values, and
retrieving (520) a matrix arranged for entropy concentration, the matrix having a different number of columns than rows, and
concentrating (530) entropy in the noise source response sequence by computing a matrix multiplication modulo a modulus between the matrix and a vector comprising the values in the noise source response sequence, thus obtaining a concentrated sequence of random values, the concentrated sequence comprising fewer values than the sequence of noise source response values.

Method 500 may comprise further operations, e.g., as described herein.

For example, the random number generation method may be a computer implemented method. For example, obtaining noise source responses, and/or retrieving a matrix may be done using a communication interface, e.g., an electronic interface, a network interface, a memory interface, etc. For example, concentrating the entropy may be done from an electronic storage, e.g., a memory, a hard drive, etc., using an electronic processor.

Many different ways of executing the method are possible, as will be apparent to a person skilled in the art. For example, the order of the steps can be performed in the shown order, but the order of the steps can be varied or some steps may be executed in parallel. Moreover, in between steps other method steps may be inserted. The inserted steps may represent refinements of the method such as described herein, or may be unrelated to the method. For example, some steps may be executed, at least partially, in parallel. Moreover, a given step may not have finished completely before a next step is started.

Embodiments of the method may be executed using software, which comprises instructions for causing a processor system to perform method 500. Software may only include those steps taken by a particular sub-entity of the system. The software may be stored in a suitable storage medium, such as a hard disk, a floppy, a memory, an optical disc, etc. The software may be sent as a signal along a wire, or wireless, or using a data network, e.g., the Internet. The software may be made available for download and/or for remote usage on a server. Embodiments of the method may be executed using a bitstream arranged to configure programmable logic, e.g., a field-programmable gate array (FPGA), to perform the method.

It will be appreciated that the presently disclosed subject matter also extends to computer programs, particularly computer programs on or in a carrier, adapted for putting the presently disclosed subject matter into practice. The program may be in the form of source code, object code, a code intermediate source, and object code such as partially compiled form, or in any other form suitable for use in the implementation of an embodiment of the method. An embodiment relating to a computer program product comprises computer executable instructions corresponding to each of the processing steps of at least one of the methods set forth. These instructions may be subdivided into subroutines and/or be stored in one or more files that may be linked statically or dynamically. Another embodiment relating to a computer program product comprises computer executable instructions corresponding to each of the devices, units and/or parts of at least one of the systems and/or products set forth.

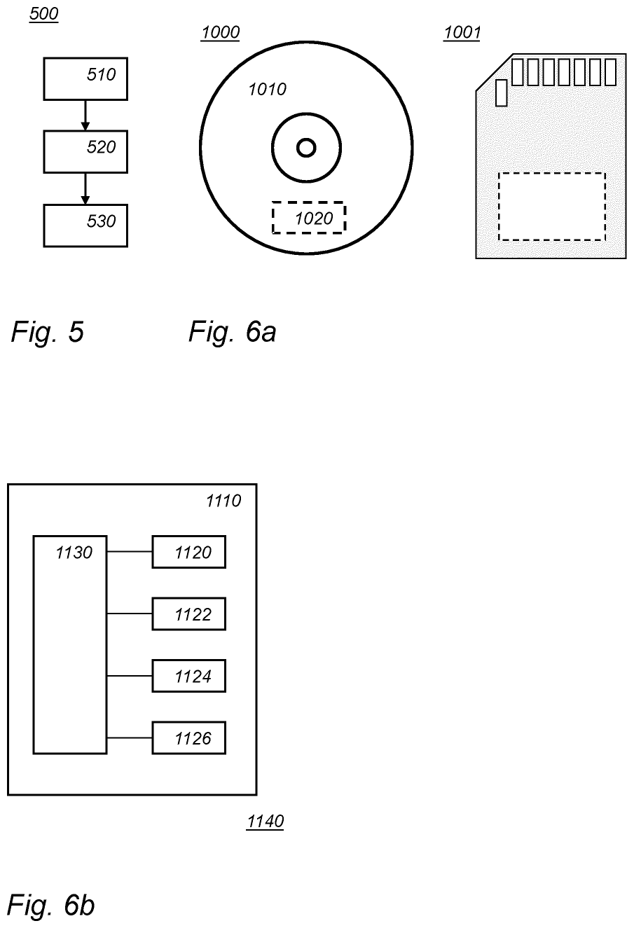

FIG. 6a shows a computer readable medium 1000 having a writable part 1010, and a computer readable medium 1001 also having a writable part. Computer readable medium 1000 is shown in the form of an optically readable medium. Computer readable medium 1001 is shown in the form of an electronic memory, in this case a memory card. Computer readable medium 1000 and 1001 may store data 1020 wherein the data may indicate instructions, which when executed by a processor system, cause a processor system to perform an embodiment of a method of random number generation, according to an embodiment. The computer program 1020 may be embodied on the computer readable medium 1000 as physical marks or by magnetization of the computer readable medium 1000. However, any other suitable embodiment is conceivable as well. Furthermore, it will be appreciated that, although the computer readable medium 1000 is shown here as an optical disc, the computer readable medium 1000 may be any suitable computer readable medium, such as a hard disk, solid state memory, flash memory, etc., and may be non-recordable or recordable. The computer program 1020 comprises instructions for causing a processor system to perform said method of random number generation.

FIG. 6b shows in a schematic representation of a processor system 1140 according to an embodiment of a random number generation system. The processor system comprises one or more integrated circuits 1110. The architecture of the one or more integrated circuits 1110 is schematically shown in FIG. 6b. Circuit 1110 comprises a processing unit 1120, e.g., a CPU, for running computer program components to execute a method according to an embodiment and/or implement its modules or units. Circuit 1110 comprises a memory 1122 for storing programming code, data, etc. Part of memory 1122 may be read-only. Circuit 1110 may comprise a communication element 1126, e.g., an antenna, connectors or both, and the like. Circuit 1110 may comprise a dedicated integrated circuit 1124 for performing part or all of the processing defined in the method. Processor 1120, memory 1122, dedicated IC 1124 and communication element 1126 may be connected to each other via an interconnect 1130, say a bus. The processor system 1110 may be arranged for contact and/or contact-less communication, using an antenna and/or connectors, respectively.

For example, in an embodiment, processor system 1140, e.g., the random number generation device may comprise a processor circuit and a memory circuit, the processor being arranged to execute software stored in the memory circuit. For example, the processor circuit may be an Intel Core i7 processor, ARM Cortex-R8, etc. In an embodiment, the processor circuit may be ARM Cortex MO. The memory circuit may be an ROM circuit, or a non-volatile memory, e.g., a flash memory. The memory circuit may be a volatile memory, e.g., an SRAM memory. In the latter case, the device may comprise a non-volatile software interface, e.g., a hard drive, a network interface, etc., arranged for providing the software.

While device 1100 is shown as including one of each described component, the various components may be duplicated in various embodiments. For example, the processor may include multiple microprocessors that are configured to independently execute the methods described herein or are configured to perform steps or subroutines of the methods described herein such that the multiple processors cooperate to achieve the functionality described herein. Further, where the device 1140 is implemented in a cloud computing system, the various hardware components may belong to separate physical systems. For example, the processor may include a first processor in a first server and a second processor in a second server.

It should be noted that the above-mentioned embodiments illustrate rather than limit the presently disclosed subject matter, and that those skilled in the art will be able to design many alternative embodiments.

In the claims, any reference signs placed between parentheses shall not be construed as limiting the claim. Use of the verb ‘comprise’ and its conjugations does not exclude the presence of elements or steps other than those stated in a claim. The article ‘a’ or ‘an’ preceding an element does not exclude the presence of a plurality of such elements. Expressions such as “at least one of” when preceding a list of elements represent a selection of all or of any subset of elements from the list. For example, the expression, “at least one of A, B, and C” should be understood as including only A, only B, only C, both A and B, both A and C, both B and C, or all of A, B, and C. The presently disclosed subject matter may be implemented by hardware comprising several distinct elements, and by a suitably programmed computer. In the device claim enumerating several parts, several of these parts may be embodied by one and the same item of hardware. The mere fact that certain measures are recited in mutually different dependent claims does not indicate that a combination of these measures cannot be used to advantage.

In the claims references in parentheses refer to reference signs in drawings of exemplifying embodiments or to formulas of embodiments, thus increasing the intelligibility of the claim. These references shall not be construed as limiting the claim.

1. A random number generation device, comprising
a sparse noise interface configured to obtain a noise source response sequence of values from a sparse noise source, the sequence comprising both noisy values and non-noisy values, and
a processing component configured to
determine a matrix arranged for entropy concentration, the matrix having a different number of columns than rows,
concentrate entropy in the noise source response sequence by computing a matrix multiplication modulo a modulus between the matrix and a vector comprising the values in the noise source response sequence, thus obtaining a concentrated sequence of random values, the concentrated sequence comprising fewer values than the sequence of noise source response values.

2. A random number generator as in claim 1, wherein the sparse noise source comprises multiple sparse noise source elements, each configured to produce one value of the noise source response sequence, obtaining the noise source response sequence from the sparse noise source comprises collecting the multiple values of the multiple sparse noise source elements.

3. A random number generator as in claim 2, wherein part of the multiple sparse noise source elements produces a noisy value, but part of the multiple sparse noise source elements produces a fixed value.

4. A random number generator as in claim 1, wherein the noise source comprises a physical unclonable function, such as
a memory PUF, in particular an SRAM PUF, and/or
a butterfly PUF comprising a sequence of butterfly PUF elements, and/or
a buskeeper PUF comprising a sequence of buskeeper PUF elements, and/or
a flip-flop PUF comprising a sequence of flip-flop PUF elements.

5. A random number generator as in am claim 1, wherein
one of the number of columns and the number of rows in the matrix is a larger number and the other is a smaller number, the larger number being at least 2 times the smaller number, or the larger number being at least 4 times the smaller number, and/or
the larger number being at most 20 times the smaller number, or the larger number being at most 10 times the smaller number, and/or
the large number being at least 64, at least 128, or at least 1024, and/or
the smaller number being at least 4, at least 64, or at least 128, and/or
the entropy in the concentrated sequence is at least 80% of the entropy in the noise source response sequence, and/or
the number of rows of the matrix is smaller than the number of columns and the rows are linearly independent, or vice versa, and/or
the number of rows of the matrix is smaller than the number of columns and any two rows have a hamming distance of at least 64, at least 128, or vice versa.

6. A random number generator as in claim 1, wherein the modulus is 2, the matrix is a binary matrix, the noise source response sequence and concentrated sequence are binary sequences.

7. A random number generation device as in claim 1, wherein the processing component is further configured to perform a statistical test on the concentrated sequence.

8. A random number generation device as in claim 1, wherein the processing component is configured to
obtain one or more further noise source response sequences from the sparse noise source, thus obtaining multiple noise source response sequences from the same sparse noise source,
obtain an updated matrix with improved entropy concentration from the multiple noise source response sequences,
store the updated matrix in a matrix storage.

9. A random number generation device as in claim 1, wherein the matrix comprises a parity check matrix of a linear error correcting code.

10. A random number generation device as in claim 9, wherein the error correcting code is a Reed-Muller code.

11. A random number generation device as in claim 1, wherein
the matrix is randomly generated, and/or
the matrix is provisioned at manufacture or at first start-up,
the matrix is generated each time before concentrating entropy in the noise source response sequence
retrieved from a matrix storage.

12. A random number generation device as in claim 1, wherein the processing component is configured to
perform a cryptographic protocol or algorithm comprising a random element, said random element being generated from the concentrated sequence, e.g., wherein the cryptographic algorithm comprises a deterministic random number generator or is configured for cryptographic key generation.

13. A random number generation method, comprising
obtaining a noise source response sequence of values from a sparse noise source, the sequence comprising both noisy values and non-noisy values, and
retrieving a matrix arranged for entropy concentration, the matrix having a different number of columns than rows, and
concentrating entropy in the noise source response sequence by computing a matrix multiplication modulo a modulus between the matrix and a vector comprising the values in the noise source response sequence, thus obtaining a concentrated sequence of random values, the concentrated sequence comprising fewer values than the sequence of noise source response values.

14. A random number generation method as in claim 13, comprising performing one or more statistical tests on the concentrated sequence.

15. A random number generation method as in claim 13, comprising
obtaining one or more further noise source response sequences from the sparse noise source, thus obtaining multiple noise source response sequences from the same sparse noise source,
obtaining a matrix with improved entropy concentration from the multiple noise source response sequences,
storing the updated matrix in the matrix storage.

16. A random number generation method as in claim 13, wherein the matrix comprises a parity check matrix of a linear error correcting code.

17. A random number generation method as in claim 13, wherein
the matrix is randomly generated, and/or
the matrix is provisioned at manufacture or at first start-up,
the matrix is generated each time before concentrating entropy in the noise source response sequence.

18. A random number generation method as in claim 13, comprising
performing a cryptographic protocol or algorithm comprising a random element, said random element being generated from the concentrated sequence, in particular wherein the cryptographic protocol comprises a deterministic random number generator, or is configured to generate a cryptographic key from the concentrated sequence.

19. A transitory or non-transitory computer readable medium comprising data
the data representing instructions, which when executed by a processor system, cause the processor system to perform the method according to claim 13.

20. A transitory or non-transitory computer readable medium comprising data,
the data representing a digital circuit configured to perform the method according to claim 13.
